(19) United States
(12) Patent Application Publication
(10) Pub. No.: US 2018/0177321 A1
(43) Pub. Date: Jun. 28, 2018

(54) PRIVACY CURTAIN SHIELD AND METHODS AND SYSTEMS RELATED THERETO

(71) Applicant: One One Three, LLC, Fall City, WA (US)

(72) Inventor: Brian Ralph Heidsiek, Seattle, WA (US)

(73) Assignee: One One Three, LLC, Fall City, WA (US)

(21) Appl. No.: 15/808,885

(22) Filed: Nov. 9, 2017

Related U.S. Application Data
(60) Provisional application No. 62/419,629, filed on Nov. 9, 2016.

(51) Int. Cl. A47H 23/08; A47H 21/00; E06B 9/24

(52) U.S. Cl. CPC A47H 23/08; A47H 13/04; E06B 9/24; A47H 21/00

(57) ABSTRACT

A shield for a privacy curtain such as is used as a room divider in a hospital room. The privacy curtain shield folds around the privacy curtain and provides an easily cleanable, removable surface that protects the privacy curtain and reduces or infection concerns and cost of cleaning and maintenance.

### CROSS-REFERENCE TO RELATED APPLICATIONS

The present application claims the benefit of copending U.S. Provisional Patent Application Ser. No. 62/419,629, filed Nov. 9, 2016, which application is incorporated herein by reference in its entirety.

### BACKGROUND

Privacy curtains in medical facilities provide patients, their families and healthcare staff with privacy and for medical procedures and care including exams, personal hygiene, changing clothes and privacy during rest. Hospital curtains also provide privacy while allowing people to pass through them without exposing the contents of the room to others or contamination. This is because they fold out of the way or move out of the way just enough to allow the person to pass through or by them with minimal visual exposure to the area being protected from view by others. They act as a soft door that can be grasped and entered or exited without much effort compared to solid devices such as a door that needs time and energy to move open and move closed. When people's hands are occupied with carrying medical related or other things, privacy curtains still allow easy passage by walking through them or by pushing them aside with a hip, shoulder or arm. The persons' body simply pushes the curtain away during passage.

Even though privacy curtains fulfill an important healthcare need, they are sometimes a nuisance to open or close, typically requiring a person to pull them open from the edge of the curtain. Even grasping the curtain edges can make opening and closing the curtain difficult for example because the tops of the curtains can stick in the rollers, and can only partially close leaving a troublesome gap. This may cause the curtain to wear out quickly and frustrate caregivers and require extra time.

Privacy curtains can both be difficult to clean, and difficult to determine if cleaning is necessary. This is because some contamination is not visible and it is very difficult to clean an object with a porous surface. A typical curtain cleaning process is expensive and requires staff time to use a ladder to take down curtains and put up the replacement ones followed by laundering of the curtain. Often the curtains are too large for normal hospital laundry services, so the curtains are sent to an outside service for cleaning. Further, privacy curtains can be a potential source of infection, bio-burden, contamination, and even healthcare-associated infections (HAI) in the patient healthcare environment.

Thus, there has gone unmet a need for improved methods of managing privacy curtain issues including, for example, reducing contamination of the curtains and improving ease of cleaning of the curtains. The present systems and methods, etc., provide at least one of these and/or other advantages.

### SUMMARY

The present systems, devices and methods, etc., provide approaches to better handle medical privacy curtains in hospital rooms and other similar locations. The systems, etc., can reduce contamination and bio-burden on privacy curtains make them easier to pull, control and otherwise, and can improve ease of cleaning.

In one aspect, In one aspect, the current devices, methods, etc., relate to a medical privacy curtain shield configured for attachment to a medical privacy curtain, the privacy curtain shield comprising a thin sheet of medically acceptable material attached to and folding around a shield edge stiffener to form a first side and a second side, and at least one attachment element configured to attach the first side and the second side to each other across the medical privacy curtain, wherein at least the shield edge stiffener can be sized and configured to form a handle for an edge of the privacy curtain when the privacy curtain shield can be attached to the edge of the privacy curtain.

In some embodiments, the curtain edge stiffener can be located mid-point of the thin sheet of the privacy curtain shield. The privacy curtain shield further can comprise a first shield edge stiffener disposed at a first end of the thin sheet and a second shield edge stiffener disposed at a second end of thin sheet, wherein the shield edge stiffeners providing vertical stiffness to the thin sheet. The first shield edge stiffener and the second shield edge stiffener can attach to each other across the medical privacy curtain.

The privacy curtain shield further can comprise curtain clips disposed within the curtain edge stiffener and comprising a slot sized and configured to accept and releasably hold the privacy curtain. The curtain clips further can comprise a blade that flexes when curtain edge stiffener shifts between open and closed modes, and when curtain edge stiffener shifts between from open to closed modes, the blade applies force to the privacy curtain to retain the privacy curtain in the curtain edge stiffener. The privacy curtain shield further can comprise webbing snap-hooks comprising a hook shape end sized and configured to attach the privacy shield to webbing located at the upper portion of a privacy curtain. The privacy curtain shield further can comprise a label comprising graphics identifying the privacy curtain shield as a location to be touched or grabbed by a use.

In some embodiments, the curtain edge stiffener can comprise at least two opposed halves connected by a flexible hinge, and the sides of the privacy curtain shield can comprise battens. The sides of the privacy curtain shield can be rigid, and at least the inner sides of the privacy curtain shield comprise a disinfectant. The curtain edge stiffener can be in the shape of a winged spine. The shield edge stiffener can be a rounded shield edge stiffener where the thin sheet folds around the rounded shield edge stiffener without any creases. In some embodiments, the thin sheet can be held in place between the rounded shield edge stiffener and a rounded stiffener cover having a substantially circular cross-section with an opening in one side.

In another aspect, the systems, etc., herein comprise a medical privacy curtain comprising a long, substantially rigid rod forming a handle at a vertical edge of the privacy curtain.

In further aspects, the systems, etc., herein comprise a privacy curtain enclosed within one or more of the privacy curtain shields herein.

Also included herein are methods of manufacturing and/or using a privacy curtain and/or privacy curtain shield as discussed herein,

These and other aspects, features and embodiments are set forth within this application, including the following Detailed Description and attached drawings. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 depicts results of a study showing user touches on a privacy curtain.

FIG. 2 depicts an exemplary mid-sized privacy curtain shield.

FIG. 3 depicts an example of attaching/detaching privacy curtain shield to a privacy curtain.

FIG. 4 depicts installation of webbing snap hooks connecting a privacy shield to a privacy curtain.

FIGS. 5A and 5B depict an embodiment were rigid curtain edge stiffener halves are joined with an integral flexible hinge.

FIG. 6 depicts a further embodiment of a privacy curtain shield as discussed herein.

FIG. 7 depicts a further embodiment of a privacy curtain shield herein comprising a mid-point-located winged spine forming a handle.

FIG. 8 depicts a further embodiment of a privacy curtain shield herein wherein the embodiment is a full-length extension that matches the height of the privacy curtain.

FIG. 9 depicts a further embodiment of a privacy curtain shield that lacks any crease at the fold.

FIGS. 10A and 10B depict a medical privacy curtain comprising a long, substantially rigid rod forming a handle at a vertical edge of the privacy curtain.

FIGS. 11A and 11B depict further embodiments of a medical privacy curtain including in cross-section comprising a long, substantially rigid rod forming a handle at a vertical edge of the privacy curtain.

### DETAILED DESCRIPTION

The present devices, systems and methods provide approaches that reduce contamination and bio-burden on medical privacy curtains and thereby reduce corresponding HAIs. The devices, systems and methods, etc., also provide improved ability to pull, control and otherwise manipulate medical privacy curtains, and improve ease of cleaning.

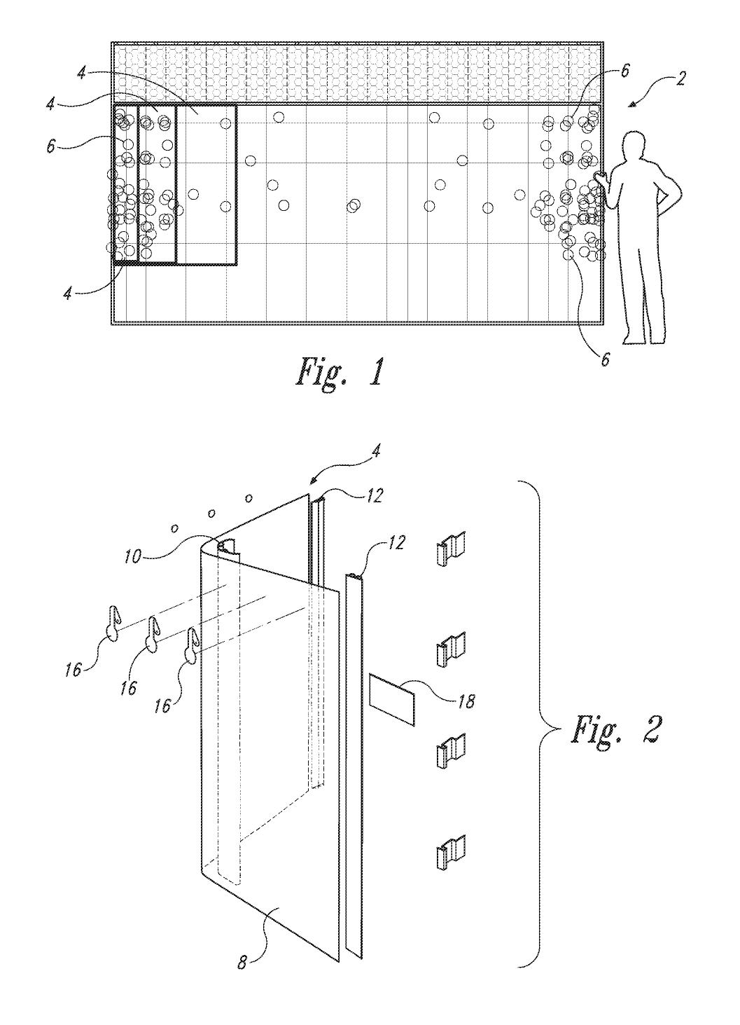

FIG. 1 depicts the results of a study by the applicant where circles 6 represent user touches of a privacy curtain 2, and shows exemplary sizes of a shield, i.e., privacy curtain shield 4, configured to protect and better manipulate such high-traffic areas on the privacy curtain. The study that found 81% of the touches of a privacy curtain were within 18″ and 90% were within 24″ of the edge, in four different room types in a community hospital. The study also observed care givers tugging on the edge to move the curtain and using a shoulder or other body part to open curtains. Some of the touches in the middle part of the curtain occurred when the curtain was closed and a caregiver near the patient would grab the middle part of the curtain to open it instead of moving to the edge to open it.

In accordance with this embodiment, a privacy curtain shield 4 is made of a highly cleanable, non-porous material that covers the edge and high touch areas on both sides of privacy curtain. The cover is constructed without any significant gaps or crevices to insure bacterial material can be easily cleaned with standard methods. The privacy curtain shield 4 may be in different sizes based on the coverage desired. For many applications, the mid-sized embodiment (approximately 22″ by 48″) will be sufficient to cover the majority of the touch locations. In a high exposure area such as an emergency department trauma room a larger size would be preferable since it is more likely the curtain will be exposed to body fluids such as blood. If desired, a privacy curtain shield 4 can be configured to cover the entire privacy curtain except for the mandatory mesh (fire code requirement) located at the top of the curtain.

The mid-sized privacy curtain shield 4 embodiment illustrated in FIG. 2 comprises a thin sheet 8 of homogeneous non-porous cover material attached to a curtain edge stiffener 10 in the fold of the shield, two shield edge stiffeners 12, four curtain clips 14 and three webbing snap-hooks 16. In this embodiment, the full-length curtain edge stiffener 10 is located mid-point (or “between vertical edges” to keep someone from slightly offsetting the fold or stiffener) of the privacy curtain shield 4 cover material, with shield edge stiffeners 12 located on each side to provide vertical stiffness while allowing free horizontal movement. The four curtain clips 14 are captured in the curtain edge stiffener 10 and together with the web snap-hooks are used to mount the privacy curtain shield 4 to any privacy curtain. A label 18 provides graphical features to help draw attention to the location on the curtain where the curtain should be touched or grabbed to open or close it, similar to a door handle on a door. The graphics and a contrasting privacy curtain shield 4 material helps encourage users to touch the covered area instead of the non-covered portions of the curtain.

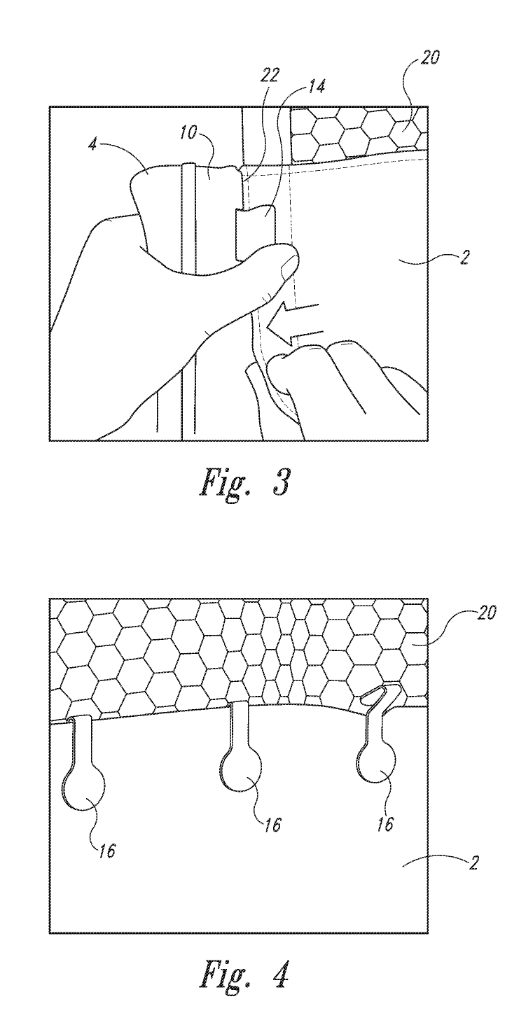

FIG. 3 depicts one example of attaching/detaching the privacy curtain shield 4 to a privacy curtain 2. Privacy curtain shield 4 is easy to install over an existing privacy curtain 2. A person simply holds the curtain edge stiffener 10 near the top curtain clip 14 of the privacy curtain shield 4 with their fingers as shown in FIG. 3, and then positions the privacy curtain 2 between the curtain edge stiffener 10 and the top curtain clip 14 while aligning the top of the curtain edge stiffener 10 with the junction of the privacy curtain 2 and the webbing 20 of the privacy curtain 2. Once the privacy curtain shield 4 is aligned, just squeeze the top curtain clip 14 to secure the privacy curtain shield 4 to the privacy curtain 2. Note: cover of the privacy curtain shield 4 can be made of transparent material so the edge of the privacy curtain 2 can be seen as the curtain clip 14 is squeezed to help position it between the curtain edge stiffener 10 and top curtain clip 14. Next, the curtain edge stiffener 10 is aligned with the edge of the curtain as the remaining three curtain clips are attached to the privacy curtain 2 to secure the full length of the privacy curtain shield 4 to the edge 22 of the privacy curtain 2.

FIG. 4 depicts installation of webbing snap-hooks 16. In this embodiment, the privacy curtain 2 is stretched flat so the curtain, curtain webbing 20 and privacy curtain shield 4 cover material are parallel to each other. Each webbing snap-hook 16 is pushed through the webbing 20 at a position that holds the privacy curtain shield 4 parallel to the curtain and snapped to a mating snap located on the privacy curtain shield 4 cover material on the back side of the curtain. The snap hook can be placed through the webbing holes adjacent to where the webbing 20 and curtain fabric meet to insure alignment of the privacy curtain shield 4 to the curtain.

If desired, fabric at the bottom of the privacy curtain shield 4 can be smoothed so the of the privacy curtain 2 and privacy curtain shield 4 are parallel. Once the privacy curtain shield 4 and curtain are smooth, the two privacy curtain shield edge stiffeners 12 can be pressed together until the curtain is captured between the edge stiffeners 12, for example by a snap detail that is formed as part of each edge stiffener 12

When removal is desired for periodic cleaning of the curtain, simply reverse the process. Attaching the privacy curtain shield 4 to the privacy curtain 2 as shown in this embodiment does not damage the privacy curtain 2 and the privacy curtain shield 4 can be installed on any privacy curtain 2. The privacy curtain shield 4 can be very easy to clean without removing the privacy curtain shield 4 or the privacy curtain 2. For example, as the rest of the patient room is cleaned or whenever it is desired, both sides of the privacy curtain shield 4 can be wiped down with normal antibacterial wipes or disinfectants according to the institutional policies and procedures. Since the privacy curtain shield 4 surface can be homogenous, there are no cracks, gaps or crevices for pathogens to remain after cleaning, thus lowering the bio-burden and increasing speed and ease of cleaning. Since the privacy curtain is now protected from contamination by the privacy curtain shield 4, it will reduce the frequency of curtain cleaning, lower the cost of curtain maintenance and extend the curtain life.

The curtain edge stiffener 10 and shield edge stiffeners 12 can be internal in or added to the privacy curtain shield 4, for example via welds as shown in FIG. 2. Each of such curtain edge stiffener 10 and shield edge stiffeners 12 significantly improve opening and closing a privacy curtain 2. For example, when the privacy curtain shield 4 is grabbed by its edge (either is peripheral edge where the shield edge stiffeners 12 are located or along its medial edge, i.e., spine, formed by folding the privacy curtain shield 4 around the privacy curtain 2), the entire end of the privacy curtain 2 can be moved by pushing or pulling on the edge. There is a significant mechanical advantage of moving the curtain with the edge stiffener because the force is transferred up closer to the roller attachment points and additionally the push force is distributed along a much greater length resulting in less curtain resistance to force in a horizontal direction.

When a user holds the edge stiffener and tips his or her hand in the direction of travel, it is also very easy to open and close the curtain farther without moving his or her feet. The edge stiffeners also make it easier to move through the privacy curtain 2 without using one's hands. The edge stiffeners also help when a shoulder is used to open the curtain as the entire edge of the curtain moves farther due to the distribution of force up to the rollers. The overall design results in easier entry and egress and significantly improves the maneuverability and control of the curtain.

The privacy curtain 2 and edge stiffeners 10 and/or 14 work together with curtain clips 14 and webbing snap-hooks 16 to insure that the privacy curtain shield 4 and privacy curtain 2 remain co-planer, which helps the privacy curtain shield 4 to not separate from the privacy curtain 2. In normal use, users will grab the edge stiffener 10 and thereby move the privacy curtain shield 4-privacy curtain 2 combination as desired. However, a user may also dramatically yank or jerk either the privacy curtain shield 4 or just the privacy curtain as needed to rapidly move the curtain. Even with vigorous physical action the curtain edge stiffener 10 or the privacy curtain shield 4 edge stiffeners act in concert to make sure the privacy curtain shield 4 stays in place and remains co-planner with the privacy curtain.

In some embodiments, the top curtain clips 14 holds the privacy curtain shield 4 in place without allowing it to slide down the privacy curtain 2. The top clip 14 may be of greater length than the lower clips, which allows it to apply greater force to the fabric of privacy curtain 2 in order to keep the privacy curtain shield 4 from sliding down the privacy curtain 2. With the top curtain clip 14 in place, the privacy curtain shield 4 is easier to install because after the top curtain clip 14 is fastened, both of the user's hands can be used for other aspects of the installation process. Proper placement of the top curtain clip 14 also acts to hold the privacy curtain shield 4 in place at the correct height so that the webbing snap-hooks 16 don't apply too much downward pressure on the mesh/webbing 20 and so that the user is insured of keeping the top of the privacy curtain shield 4 at the bottom of the mesh/webbing 20, thereby insuring the top portion of the privacy curtain 2 is covered and protected by the privacy curtain shield 4.

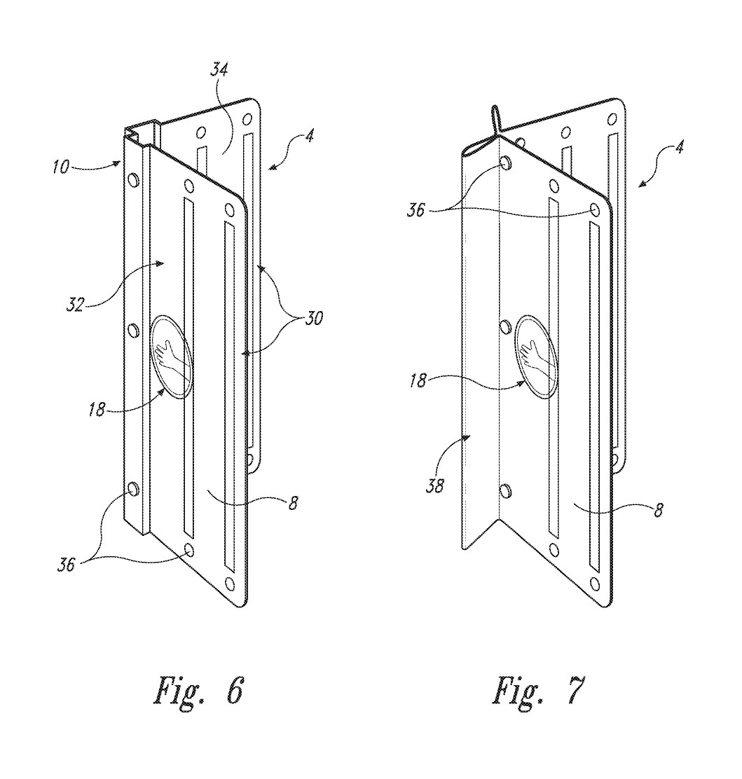

The fabric of privacy curtain 2 can vary in thickness and can include a double thickness hem. As is shown in FIG. 7, the curtain edge stiffener 10 can be configured to hold fast on a variety of thicknesses of material of fabric of privacy curtain 2. The curtain clips 14 in the curtain edge stiffener 10 can hold varying thicknesses fabric with a blade 24 that flexes between open and closed modes, while simultaneously applying force to the different thicknesses of the curtain in order to retain them in the curtain edge stiffener 10. The blade 24 has its leading edge closest to the edge of the fabric which helps the blade 24 act as a brake when the fabric is pulled away from the curtain clip 14. As the fabric is pulled the blade 24 is pulled into a more upright position thereby applying greater downward force on the fabric and holding it more securely. The edge of the blade 24 has a sharp angle which allows it to dig into the surface of the fabric without damaging it and hold it more securely. The curtain clip 14 also captures the fabric between a lip on the stiffener and curtain clip edge. This puts pressure on the fabric to hold it and also creates a path for the fabric that forces it to have one or more bends in it. Theses blends create greater friction between the curtain clip 14, curtain edge stiffener 10 and fabric, which helps to resist forces applied to the fabric in the direction of the curtain's main lateral movement along its track. \

The curtain clips 14 are held in the curtain edge stiffener 10 by an undercut and friction. The friction is of an amount to allow the curtain clips 14 to be repositioned along the curtain edge stiffener 10 as needed to accommodate various curtain construction versions.

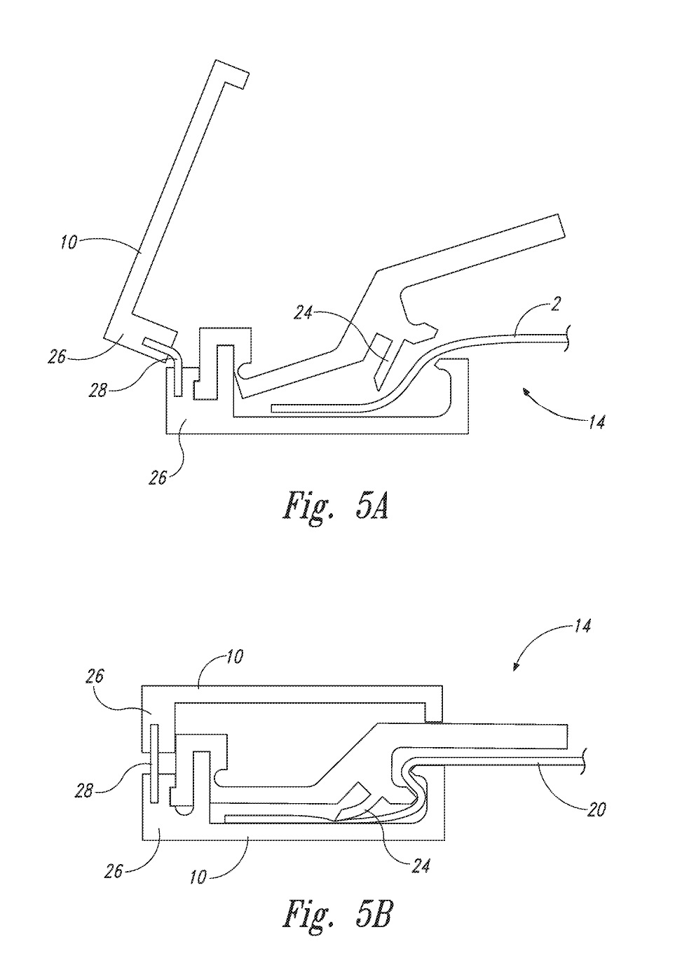

In FIGS. 5A and 5B, the rigid curtain edge stiffener halves 26 are joined with an integral flexible hinge 28. This flexible hinge 28 is flexible enough to allow the curtain edge stiffener 10 to be opened so the fabric of privacy curtain 2 can be clipped into it. The flexible hinge 28 has enough inherent stiffness and memory to return to its resting position in order to bring both halves of the stiffener together after it has been opened.

FIG. 6 depicts a further embodiment of a privacy curtain shield 4 herein comprising battens 30 and a rigid side material 32. In the embodiment shown, the battens 30 are formed in the rigid side material 32 but they can also be attached or otherwise provided. in this and other embodiments, the privacy curtain shield 4 can also comprise a disinfectant 34 such as an antibacterial, antifungal composition coated on its interior sides. The disinfectant can also be effected by using an antibacterial, antifungal material as the sides of the privacy curtain shield 4. The privacy curtain shield 4 can be made of a single sheet of material or using bonded wing construction, or otherwise as desired. The sides of the privacy curtain shield 4 can be held to each other, and thereby to the privacy curtain 2, via opposed magnets 36.

FIG. 7 depicts a further embodiment of a privacy curtain shield 4 herein comprising a mid-point-located winged spine 38 forming a handle, instead of the form of curtain edge stiffener 10 shown in other figures. It also comprises a graphic label 18 located on the side of the privacy curtain shield 4, which side provides a cover for the privacy curtain 2.

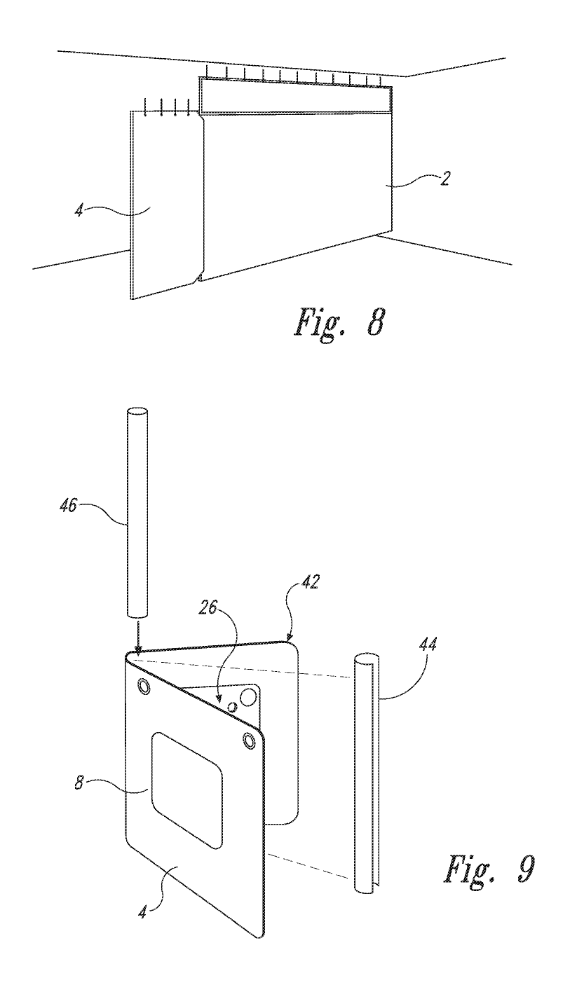

FIG. 8 depicts a further embodiment of a privacy curtain shield 4 herein wherein the embodiment is a full-length extension that matches the height of the privacy curtain 2. The privacy curtain shield 4 can if desired fasten to the existing privacy curtain 2 similar to how an extra box car is attached to a train. The privacy curtain shield 4 may be the full length of the existing curtain and may be of various widths, and may include an edge stiffener, battens, magnets or other mechanisms to fasten the box car version to the existing curtain.

This embodiment of the privacy curtain shield 4 provides a cover that:
Attaches to the curtain track for support with mesh, metal strips or rods, cords, webbing, chains, straps, hooks, snaps or other means.
Attaches to the curtain edge so that pulling and pushing it will pull and push the curtain.
A method to fasten to the curtain in a way that is removable but strong enough to resist hard tugs on the fastening system. The method may include hardware attached to the curtain to enable rapid changing of the curtain when needed for cleaning
Is easy to clean
Improves curtain use including opening, closing, entry and egress by providing vertical stiffeners
Encourages touching on the cover instead of the curtain by the use of directional graphics and iconography
Results in a lower bio-burden due to ability to clean and focus touching area
Lowers operating costs due to less frequent laundry, less labor, less room down time, longer curtain life

FIG. 9 depicts a further embodiment of a privacy curtain shield 4, like numerous other embodiments, that lacks any crease at the fold. In the embodiment depicted, privacy curtain shield 4 comprises a rounded stiffener 44 that is attached directly to the privacy curtain shield 4 through any desired approach including sewn, glued, trapped or snapped. In the case of “trapped”, the rounded stiffener 44 can be enclosed and trapped by rounded stiffener cover 46, with the thin sheet 8 held in place frictionally or otherwise between the rounded stiffener 44 and the rounded stiffener cover 46. Rounded stiffener 44 can also be molded-in to the rest of the privacy curtain shield 4 or can be inserted into a pocket in the hem of the curtain. Such opening in the fabric can be slightly below the full length of the pocket in order that the stiffener is trapped inside the pocket. The rounded stiffener 44 holds up the rest of the privacy curtain shield 4 and also can function as a handle or otherwise aid in moving the curtain and identifying where to touch the curtain. The sides of the privacy curtain shield 4 can be attached to each other, if desired, via magnets 36 opposed to metal tabs 42.

Thus, embodiments of the privacy curtain shields herein comprise one or more of the following advantages:
Covers high touch areas with a cleanable material; available in different sizes and configurations to match needs
Easy to install or remove
Easy to clean with normal hospital cleaning materials and procedures
Improves curtain use including opening, closing, entry and egress by providing an edge stiffener
Encourages touching on the cover through the use of directional graphics and iconography
Lower bio-burden (due to ability to clean and directing focus to the touching area)
Lower operating costs (due to less frequent laundry, less labor, less room down time, longer curtain life)
A privacy curtain shield may cover both sides of a privacy curtain including the edge and may extend from the curtain mesh to the floor and from the edge horizontally different distances based in the application.
A single piece of thin sheet material that is homogeneous, non-porous, and cleanable with antibacterial wipes or standard recommended disinfectants without degradation
Multiple pieces of sheet or ridged materials are joined through technology such as bonding, adhesives, radio frequency welding, ultra sonic welding, heat welding so that the assembly is homogeneous, non-porous, and cleanable with antibacterial wipes or disinfectants without degradation
A sandwich construction that includes one or more of stiffeners, battens, magnetics and graphics.
A sandwich construction where all internal components are sealed from exposure from contaminants.
A sandwich construction where there are no crevices, seams or gaps for pathogens
A sandwich construction where there are no significant bumps, protrusions or corners to make cleaning more time consuming or cause areas to be knowingly missed in cleaning
A sandwich construction where there is a clear or translucent covering over all or part of the stiffener in order to not block visibility of the stiffener or curtain
A privacy curtain shield that improves the motion and action characteristics of the existing hospital curtain. It allows people to pass through or by the curtain easily because the curtain can still move or fold out of the way with little or no effort and with minimal exposing the area that is being protected by the curtain while adding stiffeners
A privacy curtain shield that remains co-planner with the curtain under normal and extraordinary use scenarios
A privacy curtain shield where the weight of the privacy curtain shield does not overstress the curtain mounting system
A privacy curtain shield that may be mounted on any privacy curtain
The privacy curtain shield may be attached to the curtain with hooks through the mesh portion of the curtain
The privacy curtain shield may remain attached to the track or rollers via leash, the stiffener or other means when not attached to the curtain for instance when the curtain is being changed.
One side of the privacy curtain shield may attach to the other side:
   With magnetic attraction that does not damage the curtain.
   With straps or legs of connector that go through the upper mesh with barbed tips that insert into receiving slots on in the other half or other part of the shield.
   With interference fit feature that captures the curtain material in between a mushroom like post on one side of the privacy curtain shield and an opening or cavity with a recessed area for the larger part of the post to nest in on the other side of the privacy curtain shield.
   With a pin that is attached to one side of the privacy curtain shield in multiple places and this pin passes through the curtain and is held by the other half of the privacy curtain shield in designated receiving holes. The receiving holes provide a friction fit for the pins or they provide a protrusion that rests in a grove in the pin to keep the pin from pulling out. The pin has a series of groves circumferentially around the length of the pin so that pressing the pin harder in the receiving hole advances the pin father into the hole and the protrusion in the hole holds it at a position closer the base of the pin.
   With an interference fit with a clip that secures the curtain the privacy curtain shield
   With an interference fit with two linear stiffeners that captures the curtain to the privacy curtain shield
A privacy curtain shield that is made with fire retardant materials.
A privacy curtain shield that is made with anti-static materials.
A privacy curtain shield that includes markers to allow use of fluorescent light to indicate level of cleanliness.
A privacy curtain shield that is coated with anti-microbial coating
A privacy curtain shield that is made with UV resistant materials.
A privacy curtain shield that is made with clear, translucent or colored materials.
A privacy curtain shield that is resistant to degradation by bleach, quaternary ammonia, isopropyl alcohol, hydrogen peroxide and other cleaning agents used to clean and sanitize for infection control.
Battens in the privacy curtain shield keep the sides of the privacy curtain shield more upright during installation so they are out of the way of the installer and easier to manage.
Battens also add stiffness which make it easier to push the halves of the device together and improves alignment of the halves to each other
Battens create stiffness that helps connect the fasteners together with less direct attention form the user.
Battens act as a locator for the fastening system during assembly.
Battens, hooks and fasteners are located directly below points where the curtain attaches to the curtain track in order to not add rigidity to the curtain where it naturally folds during use
Battens help to keep the vertical edge of the privacy curtain shield from lifting off the curtain surface
The privacy curtain shield incorporates a ridged vertical curtain edge stiffener that is along the edge of the curtain.
   This stiffener or a portion there of, is clear or translucent so that the installer can see the curtain through the stiffener to more easily position the stiffener properly over the curtain edge.
   The stiffener contains methods for attachment to the curtain
   The stiffener uses its inherent torque characteristics to resist and succumb to the stiffener closing forces during installation and removal.
   The stiffener uses its inherent torque characteristics to resist and succumb to a spring that keeps the stiffener open until it is closed by the user.
   The stiffener becomes more stiff when closed against the other half increasing its effectiveness as a means to open and close the curtain more easily
   The stiffener is a means to save time, effort and improve efficiency by increasing the operability of the curtain by the user.
   The stiffener transfers the open/close force up closer to the privacy curtain roller attachment points and additionally the push force is distributed along a much greater length of the curtain edge resulting in less curtain resistance and easier operation.
   The stiffener allows users to be in one place and move the curtain a number of feet away from them.
   The vertical curtain side of the stiffener is a surface that will catch fingers, hands, limbs etc. in order to more easily push the curtain.
   The stiffener contains a mechanism that holds the stiffener halves apart during positioning onto the curtain and then with some degree of force from the user gives way and allows the stiffener halves to come together and stay closed due to the curtain fastening system.
   The stiffener is made up of ridged and non-rigid materials in order to allow the non-rigid material to act as a hinge.
   The halves of the privacy curtain shield can be directly attached to the rigid portion of the stiffener.
   A privacy curtain shield where the edge stiffener extends to the privacy curtain track to provide increased control over the movement of the curtain.
   A privacy curtain shield with horizontal stiffeners for the first few inches to make it easier to grab the curtain when it is full closed. In the closed position, the curtain is like an accordion and a person grabbing it may touch any part of the curtain for the first several folds. By adding a short horizontal stiffener, the edge of the protected curtain will protrude out and away from the remaining folds a few inches making it easier to grab the leading edge of the curtain. This helps focus the touching of the curtain on the protected surface instead of on any of the folds which may not be protected by the cover. It would also incorporate a stiffener to improve moving the curtain.
   A stiff member linking two rollers together in order to keep the rollers away from each other so that the curtain edge cannot fold away from the user making it easier for the user to grab the leading edge of the curtain which is protected the cover.
   A edge stiffener or privacy curtain shield that has a series of protrusions, teeth or ribs that when installed create a locking effect on the curtain to keep the curtain from being pulled away from the privacy curtain shield or stiffener or the privacy curtain shield or stiffener being pulled away from the curtain.
   The stiffener is tubular with a slot that allows it to be forced open by forcing it over both sides of the privacy curtain shield with the curtain trapped in between there by acting as a clamp to hold both sides of the privacy curtain shield to the curtain (see added sketch and end of document)
   A stiffener that is forced over interlocking features on the shield allowing the stiffener and thus the shield to clamp down on the curtain.
   A stiffener that is incorporated into the curtain assembly itself and is either removable or a permanent part of the curtain.

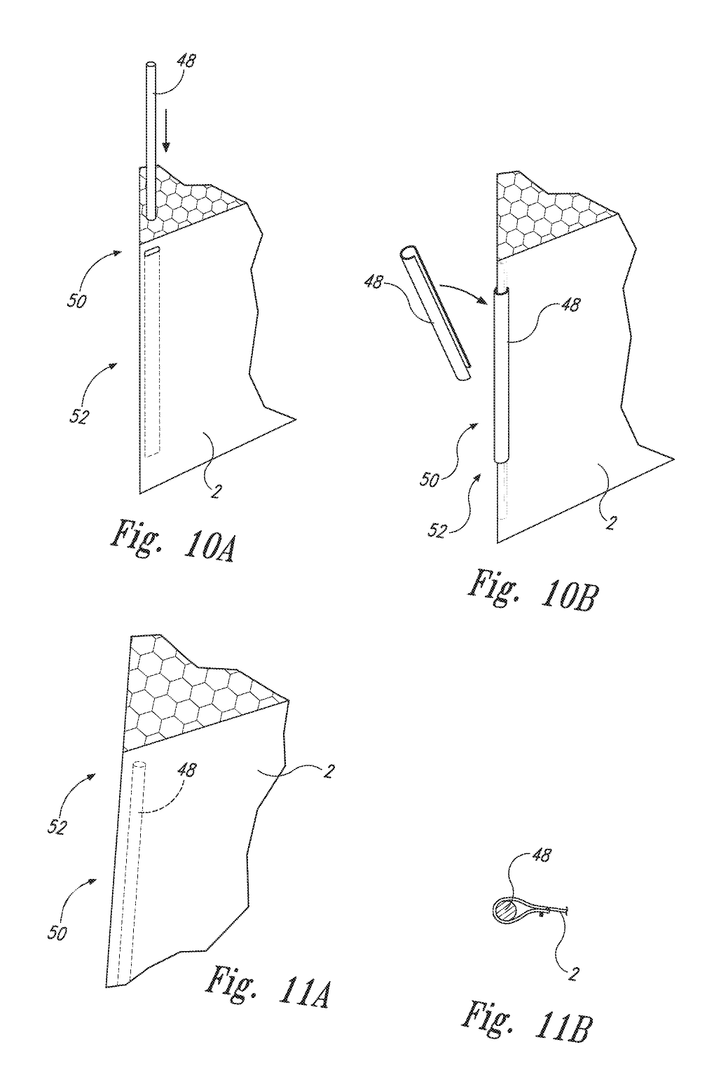

FIGS. 10A, 10B, 11A, and 11B are directed to an aspect where a medical privacy curtain 2 comprises a long, substantially rigid rod 48 forming a handle 50 at a vertical edge of the privacy curtain 2. The long, substantially rigid rod 48 can be solid or hollow, can enclose the vertical edge 52 or be enclosed within vertical edge 52.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

Unless otherwise stated, adjectives herein such as “substantially” and “about” that modify a condition or relationship characteristic of a feature or features of an embodiment, indicate that the condition or characteristic is defined to within tolerances that are acceptable for operation of the embodiment for an application for which it is intended.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

1. A medical privacy curtain shield configured for attachment to a medical privacy curtain, the medical privacy curtain shield comprising a thin sheet of medically acceptable material attached to and folding around a shield edge stiffener to form a first side and a second side, and at least one attachment element configured to attach the first side and the second side to each other across the medical privacy curtain, wherein at least the shield edge stiffener is sized and configured to form a handle for an edge of the medical privacy curtain when the medical privacy curtain shield is attached to the edge of the medical privacy curtain.

2. The medical privacy curtain shield of claim 1 wherein the curtain edge stiffener is located mid-point of the thin sheet of the medical privacy curtain shield.

3. The medical privacy curtain shield of claim 1 wherein the medical privacy curtain shield further comprises a first shield edge stiffener disposed at a first end of the thin sheet and a second shield edge stiffener disposed at a second end of thin sheet, wherein the shield edge stiffeners providing vertical stiffness to the thin sheet.

4. The medical privacy curtain shield of claim 3 wherein the first shield edge stiffener and the second shield edge stiffener attach to each other across the medical medical privacy curtain.

5. The medical privacy curtain shield of claim 1 wherein the medical privacy curtain shield further comprises curtain clips disposed within the curtain edge stiffener and comprising a slot sized and configured to accept and releasably hold the medical privacy curtain.

6. The medical privacy curtain shield of claim 5 wherein the curtain clip further comprises a blade that flexes when curtain edge stiffener shifts between open and closed modes.

7. The medical privacy curtain shield of claim 6 wherein, when the curtain edge stiffener shifts between from open to closed modes, the blade applies force to the medical privacy curtain to retain the medical privacy curtain in the curtain edge stiffener.

8. The medical privacy curtain shield of claim 7 wherein the medical privacy curtain shield further comprises webbing snap-hooks comprising a hook shape end sized and configured to attach the privacy shield to webbing located at the upper portion of a medical privacy curtain.

9. The medical privacy curtain shield of claim 1 wherein the wherein the medical privacy curtain shield further comprises a label comprising graphics identifying the medical privacy curtain shield as a location to be touched or grabbed by a user.

10. The medical privacy curtain shield of claim 1 wherein the curtain edge stiffener comprises at least two opposed halves connected by a flexible hinge.

11. The medical privacy curtain shield of claim 1 wherein the sides of the medical privacy curtain shield comprise battens.

12. The medical privacy curtain shield of claim 1 wherein the sides of the medical privacy curtain shield are rigid.

13. The medical privacy curtain shield of claim 1 wherein at least the inner sides of the medical privacy curtain shield comprise a disinfectant.

14. The medical privacy curtain shield of claim 1 wherein the curtain edge stiffener forms a winged spine.

15. The medical privacy curtain shield of claim 1 wherein the shield edge stiffener is a rounded shield edge stiffener and the thin sheet folds around the rounded shield edge stiffener without any creases

16. A system comprising a medical privacy curtain enclosed within the medical privacy curtain shield of claim 1.

17. A method comprising manufacturing a medical privacy curtain shield of claim 1.

18. A method comprising using medical privacy curtain shield of claim 1.

19. A medical privacy curtain comprising a long, substantially rigid rod forming a handle at a vertical edge of the privacy curtain.
